(19) United States
(12) Patent Application Publication
(10) Pub. No.: US 2010/0045425 A1
(43) Pub. Date: Feb. 25, 2010

(54) DATA TRANSMISSION OF SENSORS

(76) Inventor: M. Laurent Chivallier, Le Rouret (FR)

Correspondence Address: BUCHANAN, INGERSOLL & ROONEY PC, POST OFFICE BOX 1404, ALEXANDRIA, VA, 22313-1404, US

(21) Appl. No.: 12/195,841

(22) Filed: Aug. 21, 2008

(51) Int. Cl. G06F 7/04

(52) U.S. Cl. 340/5.8

(57) ABSTRACT

A method for data transmission between a sensor module for measuring and storing data and a mobile device wherein the sensor module and the mobile device have identified each other and, wherein the sensor module comprises a first secure element capable of storing a first security key and the mobile device comprises a second secure element capable of storing a second security key characterized in that the method comprises the steps of an authentication step for carrying out a security process between the sensor module and the mobile device in order to authenticate the sensor module with the mobile device by means of comparing first and second security keys; a pairing step for establishing a communication between the sensor module and the mobile device in order to enable communication therebetween; a transmission step for establishing a secure transmission of data from the sensor module to the mobile device when comparison of the first and second security keys has resulted in authentication.

### TECHNICAL FIELD OF THE INVENTION

The present invention relates to a method and system for improving the data transmission of a sensor such as a sensor used in a medical domain.

### BACKGROUND OF THE INVENTION

The use of bio-sensor (i.e. biological sensor) systems is widespread in the medical domain Bio-sensor systems provide remote patient monitoring in order to prevent, control and reduce chronic diseases such as diabetes, for example. Such systems comprise a bio-sensor located on the body of a patient and also connected to an information system. The bio-sensor detects specific data related to the disease of the patient such as the level of a component in the blood of the patient, for example. The bio-sensor then transmits the data to the information system. Thus, the information system can store and analyze the transmitted data in order to provide a diagnosis or a suggested treatment for the patient. Depending on the content of the information, the bio-sensor can effectively provide an alert if the analysis provides a critical result for the health of the patient. However, current day bio-sensors are typically bulky and as such inconvenient for the patient. Also, bio-sensors transmit data, which is not secured in any manner. This means that the data can easily be intercepted, which is unacceptable in terms of the confidentiality of personal health records.

### SUMMARY OF THE INVENTION

An object of the present invention is to alleviate some of the problems associated with the prior art systems.

More particularly, a further object of the invention is to provide a method and system for providing a secure transmission of information between a sensor and an information system.

According to one aspect of the present invention, there is provided a method for data transmission between a sensor module for measuring and storing data and a mobile device wherein the sensor module and the mobile device have identified each other and, wherein the sensor module comprises a first secure element capable of storing a first security key and the mobile device comprises a second secure element capable of storing a second security key, characterized in that the method comprises the steps of an authentication step for carrying out a security process between the sensor module and the mobile device in order to authenticate the sensor module with the mobile device by means of comparing first and second security keys; a pairing step for establishing a communication between the sensor module and the mobile device in order to enable communication therebetween; a transmission step for establishing a secure transmission of data from the sensor module to the mobile device authentication when comparison of the first and second security keys has resulted in authentication.

According to a second aspect of the present invention there is provided a system for data transmission between a sensor module for measuring and storing data and a mobile device wherein the sensor module and mobile device have identified each other, and wherein the sensor module comprises a first secure element capable of storing a first security key and the mobile device comprises a second secure element capable of storing a second security key characterized in that the system comprises the steps of an authentication module for carrying out a security process between the sensor module and the mobile device in order to authenticate the sensor module with the mobile device by means of comparing first and second security keys; a communication module for establishing a communication between the sensor module and the mobile device in order to enable communication therebetween; a transmission module for establishing a secure transmission of data from the sensor module to the mobile device when comparison of the first and second security keys has resulted in authentication.

### BRIEF DESCRIPTION OF THE DRAWINGS

Reference will now be made, by way of example, to the accompanying drawings, in which:

FIG. 1 shows a user wearing a sensor device in accordance with one embodiment of the present invention, by way of example;

FIG. 2 is a representation of the system in accordance with one embodiment of the present invention, by way of example;

FIG. 3 shows details of a secure element of the sensor as shown in FIG. 2;

FIG. 4 is a flow chart of the method steps in accordance with one embodiment of the present invention, by way of example.

### DETAILED DESCRIPTION OF THE PREFERRED EMBODIMENTS

In the following description, the use of the word sensor means any kind of sensor including bio-sensor (i.e. biological sensor).

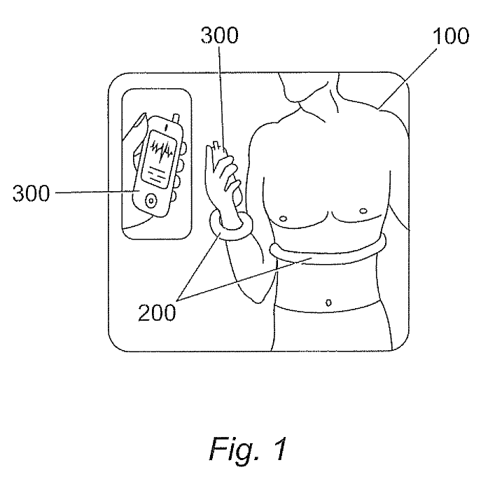

FIG. 1 shows a user 100 wearing two sensor devices 200. As a first example, a first sensor device is located on the chest of the user. As a second example, a second sensor device is located on the wrist of the user. These locations of the sensor device 200 are only examples.

The user 100 is also in possession of a mobile device 300. The mobile device 300 can be a mobile phone, a personal digital assistant or any other devices which could effect a wireless communication with another device or which could also make wireless connection to a communications network. The type of communication between the two devices may be a short range communication, for example.

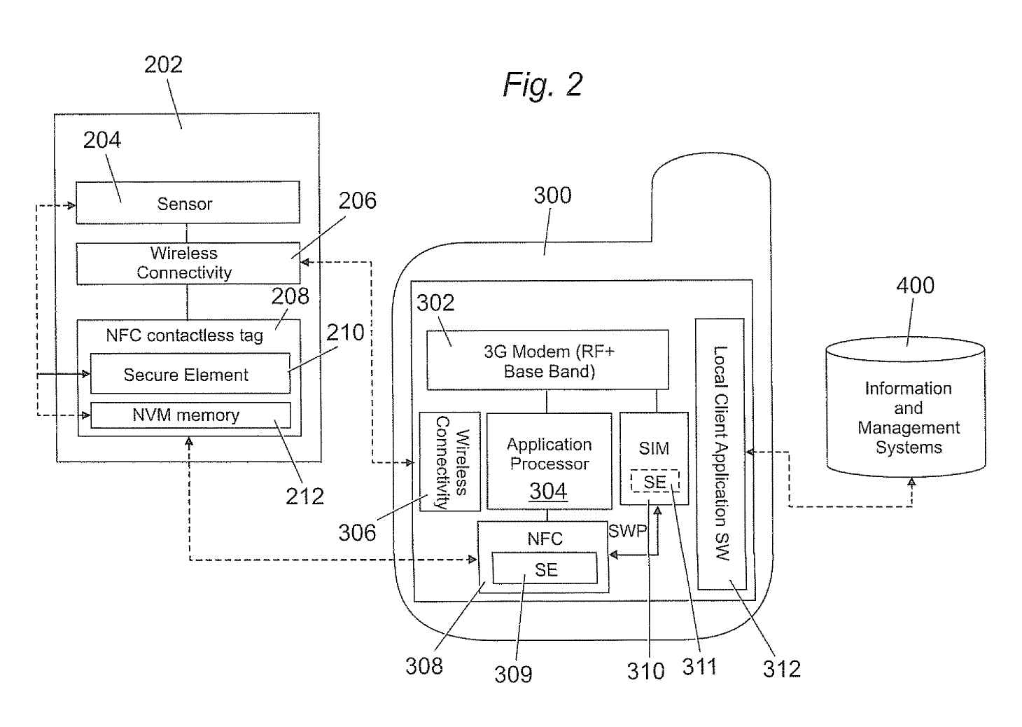

As shown in FIG. 2, the sensor device 200 comprises a specific sensor packaged module 202. The sensor module 202 comprises several components such as a sensor 204, a wireless connectivity module 206 and a tag 208. The sensor 204 can be a bio-sensor (i.e. biological sensor) in order to measure specific data like health parameters of the user such as the blood pressure or a specific blood component for example. The content of data depends on the condition (medical or otherwise) of the user and/or the location of the bio-sensor.

The sensor 204 connects to a wireless connectivity module 206. The connection between the sensor 204 and the module 206 can be a Bluetooth™ connection, a ZigBee™ connection, an ultra-wide band connection or any other appropriate means. The module 206 is a communication module typically having an ultra-low power requirement. The module 206 may connect to another wireless connectivity module located in another device such as the mobile device 300. Thus, the module 206 allows wireless connection of the sensor 204 with another device.

The wireless connectivity module 206 also connects to a tag 208. The tag 208 is a Near Field Communication (NFC) contactless tag. The tag 208 is a passive label, which comprises specific data. In the present invention, data relates to the sensor device 102 and also to the health parameters measured on the user 100 with the sensor 204. The data stored in the tag 208 can be read using a NFC module through Radio Frequency Identification (RFID) in combination with a corresponding NFC contactless tag reader. The tag reader belongs to another device such as the mobile device 300. The tag 208 includes a secure element (SE) 210 and a non-volatile memory (NVM) 212.

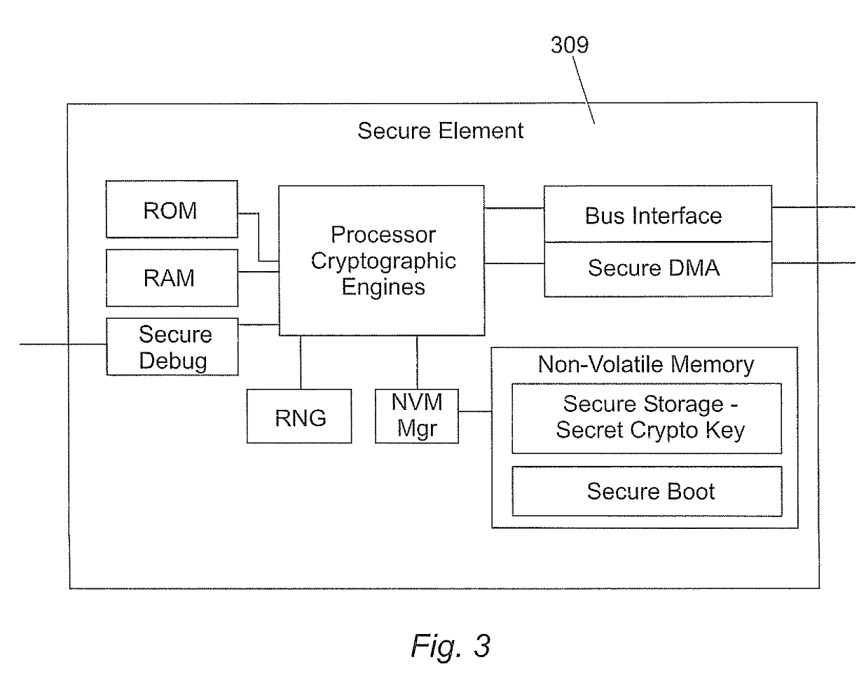

The secure element (SE) 210 comprises data which relates to the sensor (or the user or any data associated therewith). As shown in FIG. 3, the secure element 210 comprises several components such as for example, a cryptographic processor engine, a secure debug module, a secure Direct Memory Access (DMA) and/or a non-volatile memory for securely storing a secret or private cryptographic key. Including the private key within the sensor has a number of advantages which will become apparent below

The NVM 212 comprises stored data, which refers to the user sensor or any associated data. The NVM 212 stores data such as health parameters measured for the user through the sensor 204. The sensor 204 measures such data while the user is wearing the sensor device 200, which includes the sensor module 202. The amount of stored data depends on the capacity of the NVM 212. The refresh process of the NVM 212 is based on a first in first out (FIFO) mechanism where the new stored data replaces the old stored data during a measurement process.

The sensor also comprises a battery (not shown). The sensor is powered on at the first use when activated. The lifetime of the sensor depends on the lifetime of the battery and the battery could be recharged or replaced. The sensor module 202 can also be replaced if needed. During the manufacturing process of the sensor module 202, the sensor module 202 is loaded with a unique private device secret key. The sensor private key is stored in the NVM of the SE 210 of the sensor module 202. The private key allows a unique identification of the sensor module 202.

As also shown in FIG. 2, the mobile device 300 comprises different components such as a modem device 302, an application processor 304, a wireless connectivity module 306, a NFC reader 308, a Subscriber Identity Module (SIM) 310 and a local client application 312.

The mobile device 300 comprises a communication modem 302 such as a 3G modem for example. The modem 302 may connect to an application processor 304 or be integrated therewith. The modem 302 connects to both a wireless connectivity module 306 and a NFC reader 308 either via the processor 304 or directly. The modem device 302 also connects to a Subscriber Identity Module (SIM) 310. The SIM module may comprise a further Secure Element (SE) 311 as described in FIG. 3. The SIM module 310 connects the NFC reader 308 through a protocol such as a Single Wire Protocol (SWP) and may be used for connectivity purposes.

The NFC reader 308 also comprises a Secure Element (SE) 309 similar to that described in FIG. 2. The SE 309 participates in the security process in order to identify the sensor module 202. The SE 309 may include a public key which is capable of recognizing a required private key in order to effect an authentication between sensor and mobile device. This will be explained in greater detail below.

The SE 309 can also be located on a removable card. The removable card can connect the mobile device 300 through for example a specific slot on the mobile device 300 or a specific interface application. The SE 309 can also be used in conjunction with specific International Mobile Subscriber Identity (IMSI) code or International Mobile Equipment Identity (IMEI) code to enable transfer of parameters and profiles. The NFC reader 305 may also include a NVM (not shown), which has a similar function to that of the sensor NVM 212.

IMSI is a unique 15-digit code used to identify an individual user on a GSM network. IMEI (International Mobile Equipment Identity) identifies a mobile phone being used on a GSM network. The IMEI is a useful tool to stop a stolen phone from accessing a network and being used. Mobile phone owners that have their phones stolen can contact their mobile network provider and ask them to ban or shut off a phone using its IMEI number.

The mobile device 300 also comprises a local client application 312. The local client application can communicate with an information system 400 as described in FIG. 2 in any appropriate manner. The information system 400 comprises several databases related to different users. The client application 312 can then send data to the information system through wireless communication.

In the example when the sensor device 200 runs an initialization step (not shown) when the user activates the power of the sensor device located on the user, the sensor 204 of the sensor module 202 then measures user health parameters. Such health parameters may be stored in the NVM 212 of the sensor module 202 until such time as a connection is made to the mobile device.

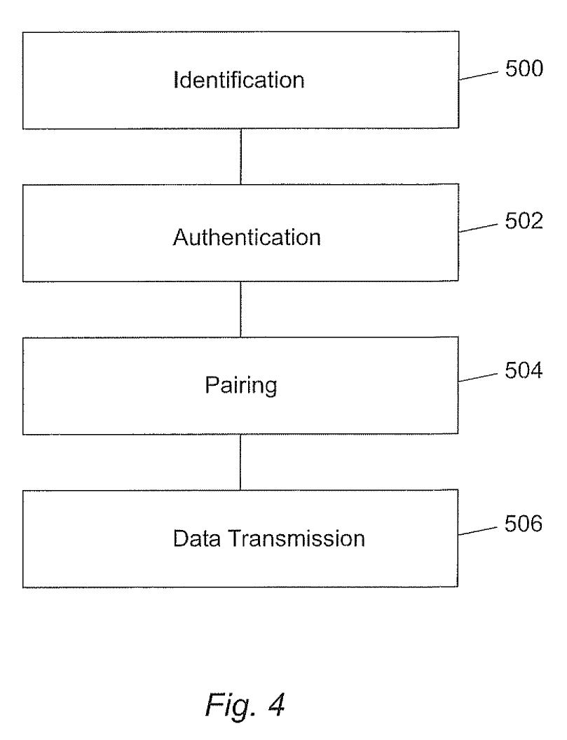

FIG. 4 shows the main steps of the process of the present invention. At the beginning of the process, the user must bring the sensor module 202 and the mobile device 300 into close proximity. Such proximity provides a communication between the NFC tag 208 of the sensor module 202 and the NFC reader 308 of the mobile device 300. This communication launches an identification process of the sensor module 202 as indicated in step 500. Thus, the sensor module 202 identifies itself to the mobile device. Once this has been carried out it is merely necessary to switch on the sensor and the mobile device in order for one to identify the other. At the end of step 500, the mobile device 300, the sensor module 202 is identified as being a matching sensor module for the mobile device 300.

The process then continues with the next step 502, which provides an authentication step in order to check that the identity of the sensor module 202 is not a fake or redundant. The authentication process uses a dual key handling secure process with a private and public key encryption through the well-known RSA encryption algorithm with digital signatures and certificates. The authentication process can occur between the sensor module 202 and the mobile device 300. The process may use the sensor private key stored in the SE 209 of the sensor module 202 and the public key stored in the SE 309 of the NFC tag reader 308 to enable authentication. The public key in the SE 309 is used to recognize and authenticate the private key of sensor 202 by means of the certificates. At the end of the mutual authentication process, if there is a matching between the private stored key in the NEC tag 209 of the sensor module 202 and the public stored key in the NFC tag reader 308, the sensor module 202 is fully authenticated as being the sensor module 202 compatible with the mobile device 300. Thereafter any communication between the sensor 202 and mobile device 300, in accordance with the private and public keys, will be encrypted so all data will only be readable by the sensor 202 and device 300.

The process proceeds with the next step 504, which deals with a “pairing step”. The pairing process automatically begins as soon as the authentication process is ended with the positive authentication of the sensor module 202 as described above. In fact, the pairing process could be part of the authentication process. The pairing process comprises the activation of both the connection module 206 of the sensor module 202 and the connection module 306 of the mobile device 300. Thus, both connection modules 206 and 306 can exchange data such as parameters and profiles for establishing a connection between the sensor module 202 and the mobile device 300. At the end of the pairing process, the sensor module 202 and the mobile device 300 are connected one with the other. The pairing process can occur between the sensor module and the mobile device in combination with the specific IMEI and IMSI codes as indicated above. These are just examples of parameters and profiles for pairing and there may be many others.

The process proceeds with the next step 506, which deals with the transmission of the data concerning the user health parameters stored in the NVM 212 of the sensor module 202. As the identification step 500, the authentication step 502 and the pairing step 504 have been completed successfully, the transmission of stored data can occur as indicated in step 506. The stored data are encrypted using the private key stored in the SE 210 of the sensor module 202. Then, the data are sent in the NVM located in the SE 309 of the mobile device 300 where it can be decrypted. The data is sent with appropriate security parameters in order to ensure the integrity and confidentiality of the transmitted data. The integrity is achieved by using and comparing Hash signatures in the data sent to the mobile device 300 and in the data received in the NVM of the SE 308 of the mobile device. If the comparison results in a positive comparison, it means that the data was not corrupted while being sent from the sensor module 202 to the mobile device 300. The confidentiality is achieved by using a cipher encryption for encrypting the stored data before their transmission.

If the transmission is interrupted for any reason the data that was not totally transferred will be resent to the NVM ( not shown) of the mobile device at the next initialization step of the sensor module 202 based on the data stored in the NVM 212.

At the end of the transmission step 506, the mobile device 300 can send all the transmitted data to an information system 400 using similar encryption if necessary. Thus, the mobile device 300 sends data to a specific database in the information system. Such a database relates to the user medical file. The transmission of the new updated data to this database provides an update of the user medical file. The data may then be used to determine the health status and possible treatment requirement for the user. Any transmission relating to patient or user data will be effected using appropriate security measures.

One of the particular advantages of the present invention is the fact that the sensor has stored thereon a private encryption key which is used to authenticate the sensor with a receiver (i.e. mobile device). Also the private encryption key ensures that all data that “leaves” the patient or user is encrypted. Before authentication all data is stored on the sensor and is only transmitted after authentication. This provides a very high level of security for the user data. This is essential for patient confidentially and medical/patient acceptance of wireless communication as a means for transmitting medical and other private data.

It will be appreciated that embodiment of this invention may be varied in many different ways and still remain within the intended scope and spirit of the invention.

Furthermore, a person skilled in the art will understand that some or all the functional entities as well as the processes themselves may be embodied in software, or one or more software-enabled modules and/or devices. Also process steps may be carried out by appropriate and equivalent modules even if these are not identified herein per se.

1. A method for data transmission between a sensor module for measuring and storing data and a mobile device wherein the sensor module and the mobile device have identified each other and, wherein the sensor module comprises a first secure element capable of storing a first security key and the mobile device comprises a second secure element capable of storing a second security key, characterized in that the method comprises the steps of:
an authentication step for carrying out a security process between the sensor module and the mobile device in order to authenticate the sensor module with the mobile device by means of comparing first and second security keys;
a pairing step for establishing a communication between the sensor module and the mobile device in order to enable communication therebetween;
a transmission step for establishing a secure transmission of data from the sensor module to the mobile device authentication when comparison of the first and second security keys has resulted in authentication.

2. The method of claim 1, further comprising transmitting data from the mobile device to an information management system.

3. The method of claim 1, further comprising collecting data from a user using the sensor.

4. The method of claim 1, wherein the transmission step further comprises encrypting data captured by the sensor for transmission to the mobile device.

5. The method of claim 1, wherein the authentication step further comprises using a private key as the first security key.

6. The method of claim 5, wherein the authentication step further comprises using a public key as the second security key.

7. The method of claim 1, further comprising storing data on the sensor prior to carrying out the authentication step.

8. A system for data transmission between a sensor module for measuring and storing data and a mobile device wherein the sensor module and mobile device have identified each other, and wherein the sensor module comprises a first secure element capable of storing a first security key and the mobile device comprises a second secure element capable of storing a second security key characterized in that the system comprises the steps of;
an authentication module for carrying out a security process between the sensor module and the mobile device in order to authenticate the sensor module with the mobile device by means of comparing first and second security keys;
a communication module for establishing a communication between the sensor module and the mobile device in order to enable communication therebetween;
a transmission module for establishing a secure transmission of data from the sensor module to the mobile device when comparison of the first and second security keys has resulted in authentication.

9. A sensor device for use in the system for data transmission between a sensor module for measuring and storing data and a mobile device wherein the sensor module and the mobile device have identified each other, and wherein the sensor module comprises a first secure element capable of storing a first security key and the mobile device comprises a second secure element capable of storing a second security key characterized in that the sensor module further comprises:
an authentication module for passing the first security key of the mobile device in order to authenticate the sensor module with the mobile device by means of comparing first and second security keys;
a communication module for establishing a communication from the sensor module to the mobile device in order to define parameters and profiles;
a transmission module for generating a secure transmission of data from the sensor module to the mobile device when comparison of the first and second security keys has resulted in authentication.

10. A mobile device for use in data transmission between a sensor module for measuring and storing data and a mobile device wherein the sensor module and the mobile device have identified each other, and wherein the sensor module comprises a first secure element capable of storing a first security key and the mobile device comprises a second secure element capable of storing a second security key characterized in that the mobile device further comprises:
an authentication module for receiving the first security key from the module in order to authenticate the sensor module with the mobile device by means of comparing first and second security keys;
a communication module for establishing a communication between the sensor module and the mobile device in order to define parameters and profiles;
a reception module for receiving a secure transmission of data from the sensor module when comparison of the first and second security keys has resulted in authentication.

11. A computer program comprising instructions for carrying out the method of claim 1 when said computer program is executed on a programmable apparatus.
